(19) United States
(12) Patent Application Publication
(10) Pub. No.: US 2008/0241317 A1
(43) Pub. Date: Oct. 2, 2008

(54) Process to obtain a food supplement and the product thus obtained

(76) Inventor: Wilton Viana, Campinas Sao Paulo (BR)

Correspondence Address: TRASK BRITT, P.O. BOX 2550, SALT LAKE CITY, UT, 84110, US

(21) Appl. No.: 11/895,529

(22) Filed: Aug. 24, 2007

(30) Foreign Application Priority Data
Mar. 26, 2007 (BR) PI 0701208-0

(51) Int. Cl. A23L 1/30; A23L 1/105; B65B 55/12

(52) U.S. Cl. 426/52; 426/392; 426/481; 426/648

(57) ABSTRACT

A PROCESS TO OBTAIN A FOOD SUPPLEMENT AND THE PRODUCT THUS OBTAINED. A new process for obtaining a food supplement and the food supplement compound itself, extracted from the Azadirachta Indica A. Juss. tree that belongs to the Meliaceae family. The product is an effective food supplement whose properties help fighting and preventing several diseases by increasing the body's resistance and by strengthening both its natural defense system and the immune system as a whole.

### TECHNICAL FIELD

The present report contains a detailed and illustrated description of a new process for obtaining a food supplement and of the food supplement itself. This effective food supplement was developed to fight and prevent several diseases by increasing the body's resistance and by strengthening both its natural defense system and the immune system as a whole.

### BACKGROUND

Aqueous and hydroalcoholic extracts of the leaves, as well as the cold-pressed seed oil of the Azadirachta Indica A. Juss. tree, which belongs to the Meliaceae family, have been used for a long time to control both agricultural pests and human and animal diseases.

These practices originally took place in Asia and Africa, then spread to Europe and are currently expanding all over the world.

Historically, the Azadirachta Indica A. Juss. tree is commonly called the “miraculous tree.” Popular wisdom led to use of its aqueous and hydroalcoholic extracts and to direct ingestion of leaves and seeds; spray solutions have been used to control diseases and pests in agriculture.

In India, Mahatma Gandhi regularly consumed its leaves; it helped him to survive his famous hunger strikes that brought about the fall of the British Empire in India. The tree is widespread in Brazil, too, and used in the above stated popular ways as well; it is further used in reforesting for timber, given its large size and the consistent values of its wood that compare to mahogany.

### DISCLOSURE OF THE INVENTION

The herein suggested process and food supplement make use of the leaves, the leave stalks, and the stalk-supporting branches, but seeds are excluded. This choice is based on the evidence that exceptional nutritious components are irregularly distributed in the different parts of the plant. Oil, e.g., is extracted form the seeds, but due to their undesirable greasy (and hypercaloric) qualities, they are not used as a food supplement.

Further, important nutrients are found in stalks and stalk-supporting branches that do not reach the leaves; including them results in a better use of plant nutrients and antioxidants.

Use of leaves, stalks and stalk-supporting branches results in an ideal composition of the herein described food compound; the final product meets the requirements of a food supplement featuring the enhanced nutritious and antioxidizing qualities of food products. This is due to the fact that its natural food qualities are preserved throughout the entire preparation process. It can therefore be very successfully used as food supplement by both healthy and ill people who suffer, e.g., from dengue fever and other infectious diseases, parasitic and metabolic diseases, etc.

### BRIEF DESCRIPTION OF THE DRAWING

The FIGURE enclosed in the present report is described below for its better understanding and illustration:

FIG. 1 shows a flowchart that depicts the plant components used to prepare the herein described food additive (leaves, stalks, and stalk-supporting branches) and that are related to the food additive manufacturing process.

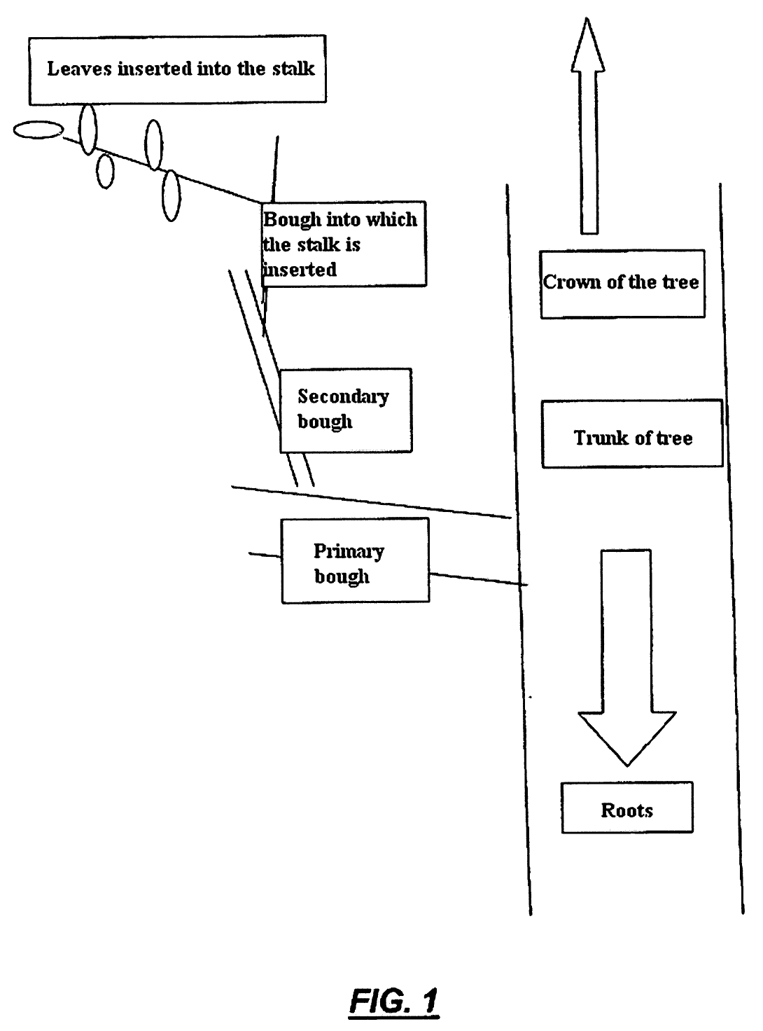

### DETAILED DESCRIPTION OF THE INVENTION

The herein suggested food supplement manufacturing process requires some special care due to Azadirachta Indica A. Juss.'s paradoxical nature; it sprouts at several botanic development levels, in any situation, and on any tropical and subtropical soil, even in conditions inhospitable to other plants similar to Meliaceae.

However, this plant is extremely demanding to fully develop and accumulate its phytochemical products that include nutrients and antioxidants. The tree requires special conditions, such as: (1) soil composition and humidity; (2) constant year-round air humidity; (3) constant year-round temperatures; (4) exposure to the east-west axis of the sun path; (5) balanced year-round wind intensity and temperature; (6) altitude of the soil area; and, (7) very low rain index throughout the entire year.

For these reasons, the tree often does not reach its ideal size and productivity needed for exploitation in all regions, not even in its original country. Plantations set up to collect the vegetal raw material for the suggested supplement must therefore meet all its botanic requirements.

The process to obtain the food supplement, object of the present patent, is divided into two initial steps. First, raw material processing into powder including extraction of nutrients and anti-oxidants. Second, preparation of the hydroalcoholic extract for human consumption.

First, the leaves, stalks, and stalk-supporting branches are collected for the extraction process of nutrients and anti-oxidants. After that, leaves, stalks, and branches are separated and cleaned.

The raw materials are then separately shadow-cured in a closed area equipped with a humidity exhauster for at least five days.

Leaves, stalks, and branches are then separately ground to powder and packed in bags, preferably in double-sheeted bags, one inside the other, under hygienic conditions that aim at their preservation. At that stage, the extracted, dehydrated, and powdered vegetal material is ready for consumption.

It is then stored and transferred to the location where the hydroalcoholic extraction takes place.

Hydroalcoholic extraction is carried out in a closed and clean area by use of a single and specific piece of equipment made up of a clean stainless steel drum, which is supported by a mechanical device used to spin the drum. The drum features a single opening where products are introduced and withdrawn.

The hydroalcoholic extraction process consists of the following steps:

Introduce a certain cereal alcohol percentage, a proportional percentage of each powder (leaves, stalks, and branches), and a complementary percentage of sanitized mineral water into the drum. Keep one third of the drum volume free for the components to mix better, which results in an enhanced penetration and extraction of the vegetal phytochemical compounds from the powders mixed with the cereal alcohol and the water.

The drum and its contents above described are slowly rotated by a mechanical system 24 hours a day for several weeks, with short operational pauses.

The drum is opened at intervals of several days to exhaust the gases produced by the water and the vegetal alcohol and to fill up evaporated water volumes proportionally.

After weeks of extraction, the product is withdrawn from the drum and filtered twice through special filters to retain solids; the resulting final liquid is filled in the kind of special plastic recipients used by compounding pharmacies to bottle their remedies. The product is stored in a closed and clean room at a constant temperature.

This process results in a hydroalcoholic food supplement extracted from the vegetal powder extract containing the edible parts of the Azadirachta Indica A. Juss. tree; it essentially contains 15.1% proteins, 0% carbohydrates, 0% fat, 16% vegetal fibers, 0.1% phosphor, 4% calcium, 46.4% limonoids and its derivatives, and 18.4% total ash. It is a liquid food product with a bitter-spicy taste essentially comprising 40% non-adulterated vegetal extract, 59.9% sterile water (obtained from the plant itself and added in distilled form during dilution), as well as 0.1% cereal alcohol.

Thus, both the food supplement manufacturing process and the obtained product, which are the object of the present patent, result in an exclusive and novel process and product in terms of composition and functions. The obtained food supplement contributes to improving the anti-oxidizing and nutritional functions of the human body and has shown to be very effective to prevent and help curing several diseases in its quality as a food supplement. Its “anti-oxidizing function” has a cleaning role in the early oxidation removal process. Consequently, the “nutrient function” provides “pure food” that is free of chemical additives that would alter the nutritious and anti-oxidizing properties of that plant and that results in an efficient food supplement that can be easily acquired by all consumers.

Our concept is based on the fact that human beings are mammals and that, according to the laws of nature, newborn mammals first survive by being fed with their mother's breast milk. After a weaning period, they start eating the food imposed by nature to their species (rabbits eat grass, wolves eat rabbits, etc., according to the food chain). To summarize, nutrition habits of each mammal specie is defined by nature and only a specific type of food meets the physical needs of a certain type of mammal species.

Humans are the only species that has violated that natural law:

It is the only species that keeps using animal milk as a part of its nutrition after weaning; it has spoiled food even further:

1—Natural food is rarely accepted and used as such (e.g., natural fruit and vegetables);

2—Humans adulterate natural food by seasoning and cooking it and promote biochemical changes to their bodies by eating food that does not suit their mammal bodies. In addition to that, they keep breathing air that has been chemical altered by pollution.

These food and breathing habits result in serious consequences; they lower the natural defense capacity of the body and the immune system as a whole.

The majority of the so-called “healthy” people actually show a deficient physical immune system due to the influence of “normal stress” on their daily lives, the low quality of the air they breathe, nutritional deficiencies, and other factors.

People prone to diseases usually feature a weaker immune system, which promotes the spreading of bacteria, fungi, virus, and parasites, in addition to reducing the physiological resources of the human body, such as the cardio-respiratory system, the neurological system, the glandular system, the gastro-intestinal system, the osteomuscular system and its extensions (nails, hair, etc.), as well as the mental system (irritability, depression and sleep disorders). Therefore, the ability of performing physically and mentally is rooted in our lifestyle, food and breathing habits.

The present anti-oxidizing and nutritional food supplement promotes the recovery and strengthening of the immune system and supplies the natural defense system of the body with the capacity to prevent and fight the penalties of a weakened immune system by complementing the daily human diet, i.e., it contributes to an improved life quality (physical and mental disposition) and supports the capability to prevent and fight diseases.

Human food habits have replaced natural alimentation provided by nature for mammals and have resulted in the ingestion of chemical products that differ from those contained in natural food. In addition to that, breathing polluted air also implies in chemically different products that are not found in pure air, which results in a kind of “pollution” of the body called “early oxidation.” That, in turn, is responsible for our impaired health.

Early oxidation is, therefore, a determinant factor of “illnesses and early deaths.”

“Natural death” is caused by the mammal species' genetically programmed lifetime termination. A dog's life, e.g., lasts approximately 15 years, a horse's life lasts about 20 years, etc.

In veterinary medicine, no reference can be found regarding “diseases and death of wild animals” that occur before their genetically defined life span. Among mammals, only animals that depend on humans to survive get ill, i.e., “animals domesticated by humans”, since man forces his own food, behavior concepts, and habits upon them, ignoring the supreme natural laws.

Thus, taking into account the above described functions and application of the product and its nutritious and anti-oxidizing properties, one may clearly conclude that the PROCESS TO OBTAIN A FOOD SUPPLEMENT AND THE PRODUCT THUS OBTAINED are a new state-of-the-art process and compound that feature innovation, inventive activity, and novel industrialization, which is why they deserve the privilege to get an Invention patent.

1. A PROCESS TO OBTAIN A FOOD SUPPLEMENT AND THE PRODUCT THUS OBTAINED, wherein the process is characterized by two main steps:
a first step defining a processing of a raw material to powder by extracting nutrients and anti-oxidizing agents from a Azadirachta Indica A. Juss. tree, which belongs to the Meliaceae; and
a second step of manufacturing a hydroalcoholic extract from said powder intended for human consumption.

2. THE PROCESS TO OBTAIN A FOOD SUPPLEMENT AND THE PRODUCT THUS OBTAINED, according to claim 1, wherein the process is characterized by nutrients and anti-oxidizing agents that are extracted from the leaves, stalks, and stalk-supporting branches of the Azadirachta Indica A. Juss. tree of the Meliaceae family.

3. THE PROCESS TO OBTAIN A FOOD SUPPLEMENT AND THE PRODUCT THUS OBTAINED, according to claim 1, wherein the process is characterized by:
raw material preparation that includes cleaning and separation of leaves, stalks, and branches
separately shadow-curing the raw materials in a closed area equipped with a humidity exhauster for at least five days; and
then separately grounding said raw materials to powder and packing said raw materials in bags, preferably in double-sheeted bags, one inside the other, under hygienic conditions aimed at the preservation of said raw materials, to obtain an extracted, dehydrated, and powdered vegetal material, which is then ready for consumption.

4. THE PROCESS TO OBTAIN A FOOD SUPPLEMENT AND THE PRODUCT THUS OBTAINED, according to claim 1, wherein the process is characterized by:
hydroalcoholic extraction carried out in a closed and clean area by use of a single and specific piece of equipment made up of a clean stainless steel drum supported by a mechanical device that rotates the drum, said drumming featuring a single opening to introduce and withdraw products;
placing a certain cereal alcohol percentage, a proportional percentage of each powder (leaves, stalks, and branches), and a complementary percentage of sanitized mineral water into the drum;
slowly rotating the drum by a mechanical device 24 hours a day, for several weeks, with short operational pauses;
opening the drum at intervals of several days to exhaust the gases produced by the water and the vegetal alcohol and to fill up evaporated water volumes proportionally;
withdrawing a product from the drum after weeks of extraction;
filtering said product twice through special filters to retain solids; and
placing the resulting final liquid in special plastic receptacles.

5. THE PROCESS TO OBTAIN A FOOD SUPPLEMENT AND THE PRODUCT THUS OBTAINED, wherein the food supplement product is characterized by being a powder and/or hydroalcoholic food supplement extracted from the dehydrated vegetal powder extract of certain parts of the Azadirachta Indica A. Juss. tree; the total dehydrated powder (a mixture of leaf, stalk, and branch powders) essentially containing 15.1% proteins, 0% carbohydrates, 0% fat, 16% vegetal fibers, 0.1% phosphor, 4% calcium, 46.4% limonoids and its derivatives, and 18.4% total ash; the liquid food supplement featuring a bitter-spicy taste, a forest aroma, a dark green color, and comprising 40% non-adulterated vegetal extract (powder comprising 40% non-adulterated vegetal extract (powder mixture), 59.9% sterile water (obtained from the plant itself and added in distilled form during dilution), as well as 0.1% cereal alcohol.

6. THE PROCESS TO OBTAIN A FOOD SUPPLEMENT AND THE PRODUCT THUS OBTAINED, according to claim 2, wherein the process is characterized by:
raw material preparation that includes cleaning and separation of leaves, stalks, and branches;
separately shadow-curing the raw materials in a closed area equipped with a humidity exhauster for at least five days; and
then separately grounding said raw materials to powder and packing said raw materials in bags, preferably in double-sheeted bags, one inside the other, under hygienic conditions aimed at the preservation of said raw materials, to obtain an extracted, dehydrated, and powdered vegetal material, which is then ready for consumption.

7. THE PROCESS TO OBTAIN A FOOD SUPPLEMENT AND THE PRODUCT THUS OBTAINED, according to claim 2 wherein the process is characterized by:
hydroalcoholic extraction carried out in a closed and clean area by use of a single and specific piece of equipment made up of a clean stainless steel drum supported by a mechanical device that rotates the drum, said drumming featuring a single opening to introduce and withdraw products;
placing a certain cereal alcohol percentage, a proportional percentage of each powder (leaves, stalks, and branches), and a complementary percentage of sanitized mineral water into the drum;
slowly rotating the drum by a mechanical device 24 hours a day, for several weeks, with short operational Pauses;
opening the drum at intervals of several days to exhaust the gases produced by the water and the vegetal alcohol and to fill up evaporated water volumes proportionally;
withdrawing a product after weeks of extraction from the drum;
filtering said product twice through special filters to retain solids; and
placing the resulting final liquid in special plastic receptacles.
